(19) United States
(12) Patent Application Publication
(10) Pub. No.: US 2009/0265606 A1
(43) Pub. Date: Oct. 22, 2009

(54) Method for Creating a Table in the Automation Environment

(75) Inventors: Anja Bluhm, Feucht (DE); Rene Houdek, Nurnberg (DE); Fabio Perna, Nurnberg (DE); Christian Prechtl, Koln (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 12/386,154

(22) Filed: Apr. 14, 2009

(30) Foreign Application Priority Data
Apr. 16, 2008 (EP) 08007466.9

(51) Int. Cl. G06F 17/25

(52) U.S. Cl. 715/228

(57) ABSTRACT

Project planning software is made available to a user within an automation environment. Table editors or grids are implemented therein. Some columns are logically linked to one another, which would preclude such columns being separated. Nevertheless, it is possible to separate columns within the course of moving or hiding them. The logic of the table editor is thus destroyed however. A “Twin Columns” feature is provided and columns which are logically linked to one another are defined as a unit. They are thus permanently coupled to one another and cannot be separated within the course of the processing of a table. The logic of the table editor is thus maintained.

### CROSS REFERENCE TO RELATED APPLICATIONS

This application claims priority of European Patent Application No. 08007466.9 EP filed Apr. 16, 2008, which is incorporated by reference herein in its entirety.

### FIELD OF INVENTION

The invention relates to a method and a device for creating a table in the automation environment.

### BACKGROUND OF INVENTION

The term PLC (Programmable Logic Control) is understood to mean a digital computer and/or control device, which is used to automate industrial processes such as for instance the control of machines or conveyor belts.

Project planning software is in principle made available to the customer/end user in the automation environment. With the aid of this project planning software, said customer/end user then creates on his/her part suitable programs, tables/lists and data for his/her specific application, which are then run on PLCs.

So-called grids or table editors are implemented in the project planning software in particular. A table editor is a table or list (as yet unfilled with data), which is transferred to the user as part of the project planning software. The table editor has a plurality of columns, which may be logically linked to each another. Technical facilities, like for instance a module, are virtually mapped in the table editor of the project planning software. A map of the relevant module as an (empty) lattice is thus communicated to the user. The lattice therefore contains a map of the properties of the module, in other words the input and output parameters. The user then fills the table editor with the relevant data.

Certain columns can now be logically linked or coupled to one another by way of their contents. A separation of these logically linked columns is permitted in the prior art for the (entirely sensible) instance of being able to process columns during the course of moving or hiding them, which gives the user a degree of flexibility in the processing of his/her tables and lists. If columns which are logically linked and/or coupled to one another are separated, the logic of the table editor is thus destroyed.

If the movement or showing/hiding of columns is permitted in principle, the user must be able to retrieve the separated columns at any time in order to be able to maintain the logic of the table editor. This is done by selecting a correspondingly long and detailed, self-explanatory column header. Logically connected columns can thus be re-identified and merged even after a separation. However this must be carried out manually, which, in practice, involves a considerable expenditure of time for the user.

Also known from the prior art is the process of basically suppressing the moving, showing/hiding of the columns. The user thus lacks essential means when creating his/her own solutions during the project planning of his/her software in the automation environment.

### SUMMARY OF INVENTION

An object of the invention is to demonstrate a way in which the processing of logically connected columns can be configured efficiently in a table editor.

The object of the invention is achieved by a method and a device as claimed in the claims.

The invention is advantageous in that, when creating the project planning software, certain columns in the table editor are defined as connected and thus virtually form a unit. This feature known as “Twin Columns” thus offers all current functions, which are also made available for an individual column in the grid. This also allows the user to adapt the column arrangement to his requirements, without any disadvantageous splitting up of connected columns when doing so. The invention finally allows for a short label in the column header, since the marking is always viewed in the context of the adjacent “Twin Columns”. An optimized screen layout and short and self-explanatory markings also result.

### BRIEF DESCRIPTION OF THE DRAWINGS

The invention is described in more detail below with reference to an exemplary embodiment shown in the figures, in which;

FIG. 1 shows the situation in the table editor,

FIG. 2 shows the visualization of logically assigned columns when moving said columns,

FIG. 3 shows the context menu with a grouping for showing/hiding the “Twin Columns”.

### DETAILED DESCRIPTION OF INVENTION

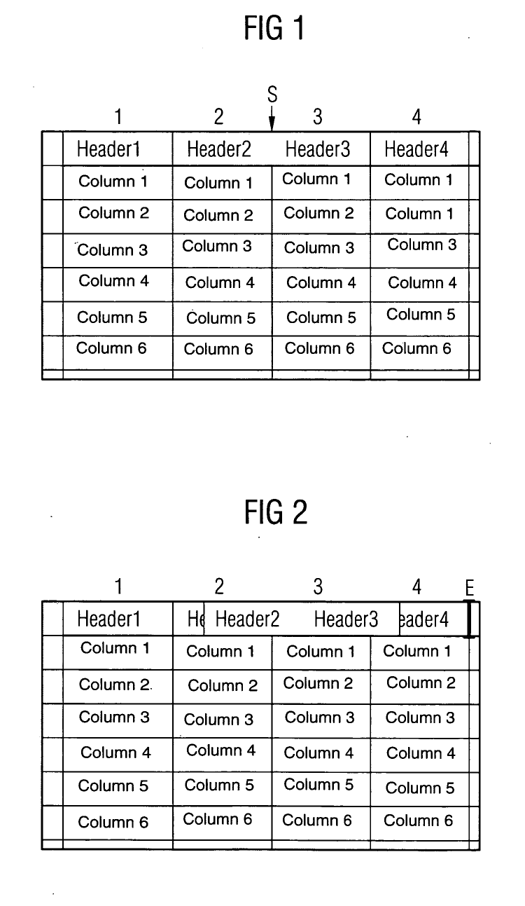

FIG. 1 shows the situation in the table editor. Accordingly, a first column 1 is provided, which indicates a plurality of rows, row 1 . . . row 6. 6 rows are thus shown by way of example. Column 1 also has the column header Header1. Furthermore, columns 2, 3, 4 with the respective column headers Header2, Header3, Header4 can be seen in FIG. 1. The columns 2, 3, 4 likewise have 6 rows.

The columns 2, 3 are now to be logically linked to one another in accordance with the present exemplary embodiment. A “Twin Columns” feature is provided, which ensures that the two columns 2, 3 cannot be separated when being moved or hidden. The corresponding situation can be seen in FIG. 2. This is achieved by the two columns, the contents of which are logically linked to one another, being defined as one unit. This circumstance is indicated to the user, e.g. by different-colored or less contrast-rich separators S, as shown in FIG. 1, visualized in the column header.

According to the present exemplary embodiment, only two logically assigned columns 2, 3 are claimed, which have a 1:1 assignment. This means that row 1 of column 2 is assigned to row 1 of column 3 etc. The invention is however principally not restricted to two columns. A plurality of logically assigned columns can thus be used. Here the assignment can also assume considerably more complex forms than in the case of a 1:1 assignment.

Each of the “Twin Columns” has all column functions which are known per se within a grid. This includes column-by-column selection and sorting behavior as well as changing the column width by means of dragging the separators.

Nevertheless, there are decisive differences in respect of the remaining columns in the grid, in other words the columns which do not form a unit with another column.

The columns can only ever be moved together by the user. If the user therefore initiates the movement (e.g. by way of actuating the mouse and dragging across one of the headers of the group of “Twin Columns”), all columns which belong to this group are thus also moved. The user therefore immediately obtains visual feedback, e.g. via the display of a shadow object of all relevant headers during the movement process (FIG. 2). The movement process itself does not differ here from that of an individual column, i.e. it is dependent on the cursor movement when dragging an insertion cursor E in the grid header, at the position of which the group of “Twin Columns” is inserted after releasing the left mouse key. The corresponding situation can be seen in FIG. 2, which shows the moment at which column 2 is being moved. Since this column is logically assigned to column 3, said column is also moved.

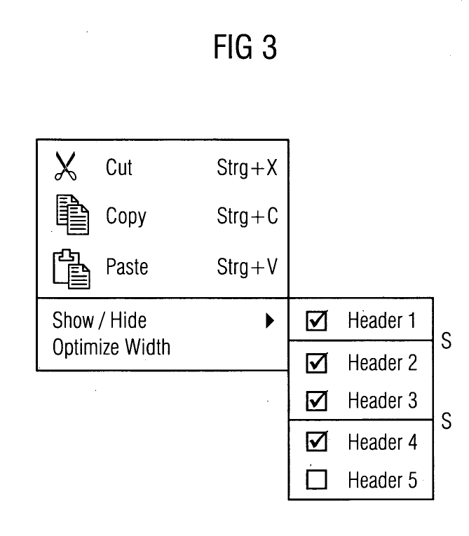

FIG. 3 shows the showing/hiding of the “Twin Columns” by way of the header context menu. Both columns can only ever be shown or hidden together. The connected columns are visualized to the user by way of menu groups for instance, in which the selection/deselection of a checkbox deletes/sets all checkboxes associated with this group. The reduction of each individual “Twin Column” by dragging the header separator (even until the relevant column disappears) is possible irrespective of this mutual showing/hiding of the “Twin Columns”. In this case the user obtains a suitable visualization of the hidden “Twin Columns”, i.e. a visual indication that additional columns can be shown.

1.-7. (canceled)

8. A method for creating a table in an automation environment, comprising:
providing a table editor having a plurality of columns, the contents of a first column and a second column being logically linked to one another; and
defining the first column and the second column as one unit.

9. The method as claimed in claim 8, further comprising:
visualizing the first column and the second column as one optical unit to a user.

10. The method as claimed in claim 8, further comprising:
visualizing the first column and the second column by different-colored separators in a column header to a user.

11. The method as claimed in claim 9, further comprising:
visualizing the first column and the second column by different-colored separators in a column header to the user.

12. The method as claimed in one of claims 8, wherein the first column and the second column are only ever be moved together.

13. The method as claimed in one of claims 9, wherein the first column and the second column are only ever be moved together.

14. The method as claimed in one of claims 10, wherein the first column and the second column are only ever be moved together.

15. The method as claimed in one of claims 8, wherein the first column and the second column are only ever be shown or hidden together.

16. The method as claimed in one of claims 9, wherein the first column and the second column are only ever be shown or hidden together.

17. The method as claimed in one of claims 10, wherein the first column and the second column are only ever be shown or hidden together.

18. A device for creating a table in an automation environment, comprising:
a table editor having a plurality of columns, the contents of a first column and a second column being logically linked to one another; and
a device configured to define the first column and the second column as one unit.

19. The device as claimed in claim 18, further comprising:
a further device configured to visualize the first column and the second column as one optical unit to a user.
